(19) United States
(12) Patent Application Publication
(10) Pub. No.: US 2011/0159338 A1
(43) Pub. Date: Jun. 30, 2011

(54) MOUNTING APPARATUS FOR CELL BATTERY

(75) Inventor: ZHAN-YANG LI, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/852,477

(22) Filed: Aug. 7, 2010

(30) Foreign Application Priority Data
Dec. 29, 2009 (CN) 200920318866.1

(51) Int. Cl. H01M 2/10

(52) U.S. Cl. 429/100

(57) ABSTRACT

A mounting apparatus includes a chassis, a first securing plate, a second securing plate and a bracket. The first and second securing plates are secured to the chassis. The bracket is secured between the first and second securing plates and includes a top wall, a first sidewall, and a second sidewall. The first and second sidewalls are located on the top wall. The top wall and the first and second sidewalls are configured for receiving a cell battery. The first sidewall defines a receiving slot for receiving a cable of the cell battery.

### BACKGROUND

1. Technical Field

The present disclosure relates to a mounting apparatus for securing a cell battery to a chassis.

2. Description of Related Art

Usually, a plurality of cell batteries is used in a server for providing power to electronic elements. A more convenient mounting apparatus to secure the cell batteries is needed.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, cutaway view of a mounting apparatus and two cell batteries in accordance with an embodiment.

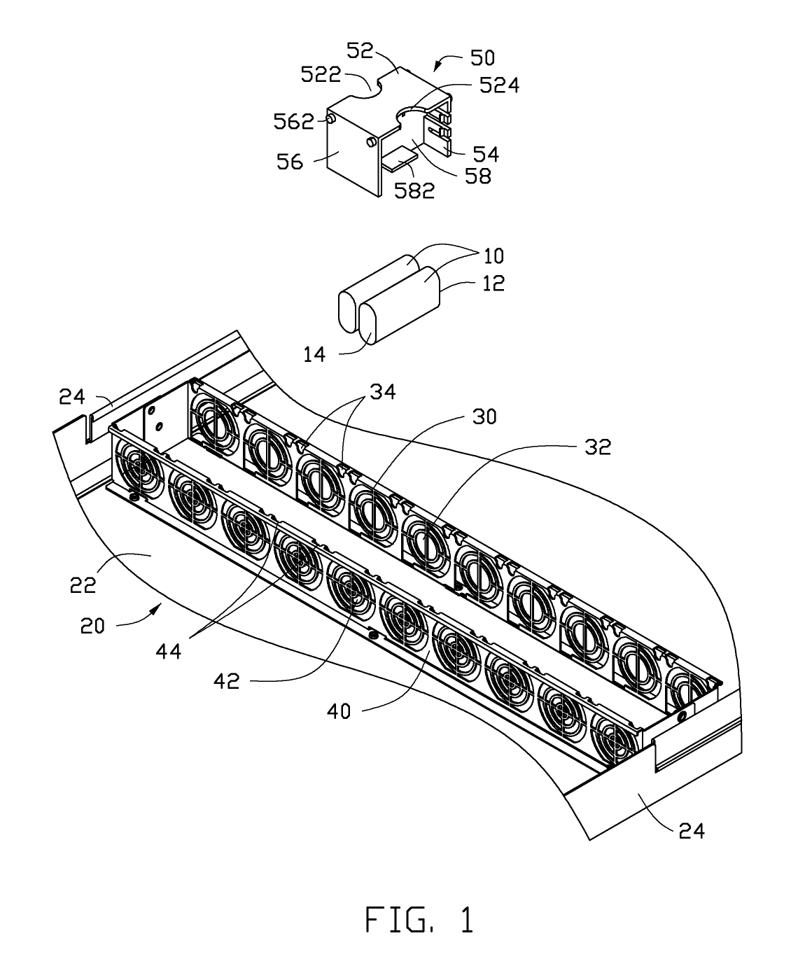

FIG. 2 is an isometric view of the bracket of FIG. 1.

FIG. 3 is an assembled view of the bracket and the cell batteries of FIG. 1.

FIG. 4 is an assembled view of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Referring to FIG. 10, a mounting apparatus in accordance with an embodiment is configured for securing two cell batteries 10. Each cell battery 10 has a first end 12 and a second end 14 opposite to the first end 12. A cable 122 extends from the first end 12, for electronically coupling the cell battery 10 with electronic element.

The mounting apparatus includes a chassis 20 and a bracket 50.

The chassis 20 includes a bottom plate 22, and two opposite side plates 24 located on the bottom plate 22. A first securing plate 30 and a second securing plate 40 are secured to the bottom plate 22 between the side plates 24. A plurality of first ventilation holes 32 is defined in the first securing plate 30. Two first positioning slots 34 are defined in a top edge of the first securing plate 30 above each first ventilation hole 32. A plurality of second ventilation holes 42 is defined in the second securing plate 40, corresponding to the first ventilation holes 32. Two second positioning slots 44 are defined in a top edge of the second securing plate 40 above each second ventilation holes 42, and the second positioning slots 44 correspond to the first positioning slots 34. In one embodiment, the side plates 24 are substantially parallel to each other and perpendicular to the bottom plate 22, and the first and second securing plates 30, 40 are substantially parallel to each other and perpendicular to the bottom plate 22 and the side plates 24.

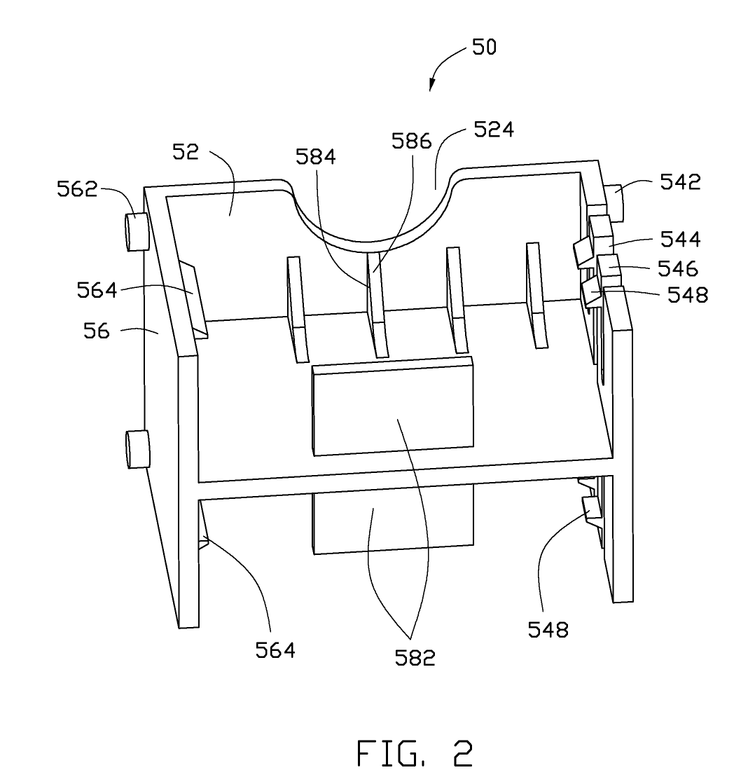

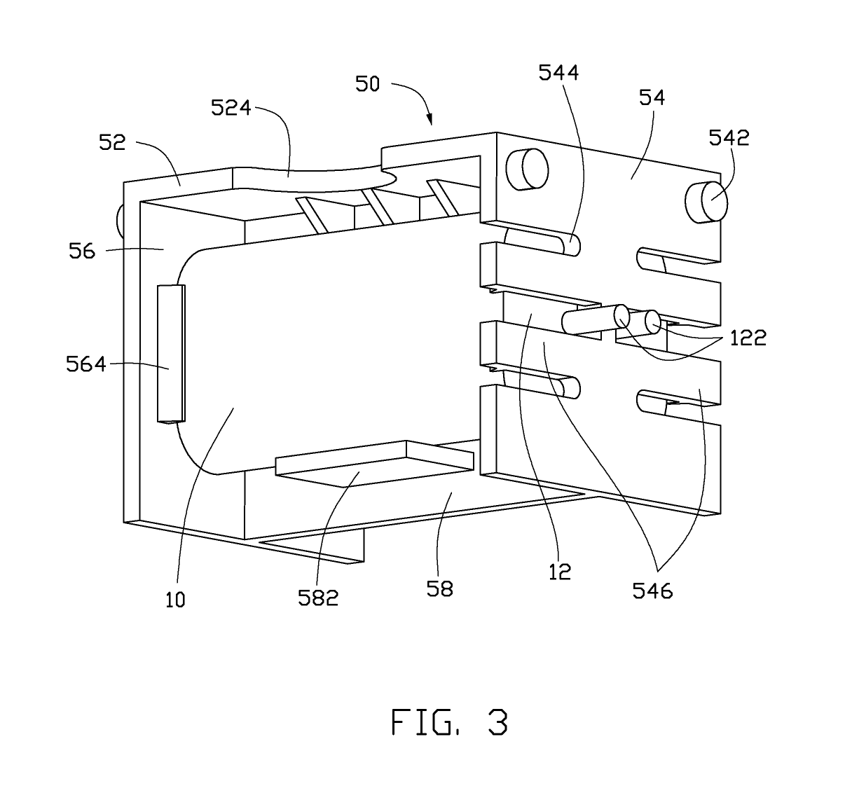

The bracket 50 includes a top wall 52, a first sidewall 54, and a second sidewall 56. The first and second sidewalls 54, 56 are located on opposite edges of the top wall 52. An intermediate board 58 is located on the top wall 52 between the first and second sidewalls 54, 56. Two cutouts 522, 524 are defined in opposite edges of the top wall 52 between the first and second sidewalls 54, 56. Referring to FIGS. 2-3, two first positioning posts 542 are located on an outer surface of the first sidewall 54, adjacent the top wall 52. Three receiving slots 544 are defined in each of opposite edges of the first sidewall 54, at two sides of the intermediate board 58, and four locking portions 546 are therefore formed on the first sidewall 54. The locking portions 546 are resiliently deformable. A locking protrusion 548 is located on each locking portion 546. Two second positioning posts 562 are located on an outer surface of the second sidewall 56, adjacent the top wall 52. Two positioning blocks 564 are located on an inner surface of the second sidewall 56 at two opposite sides of the intermediate board 58. Two positioning pieces 582 are located on opposite surfaces of the intermediate board 58, away from the top wall 52. A plurality of guiding pieces 584 is located on the opposite surfaces of the intermediate board 58 and connected to the top wall 52. Each guiding pieces 584 has a slanted surface 586.

Referring to FIG. 3, in assembly, the second end 14 of the cell battery 10 is inserted in the bracket 50 between the positioning block 564 and the top wall 52. The first end 12 of the cell battery 10 is inserted into the bracket 50 between the locking protrusion 548 and the top wall 52. The cable 122 is inserted into one of the receiving slot 544. The cell battery 10 is positioned between the positioning piece 582 and the guiding pieces 584 of the intermediate board 58. The slanted surface 586 of the guiding pieces 584 is used to direct the cell battery 11 to slide in between positioning piece 582 and the guiding pieces 584.

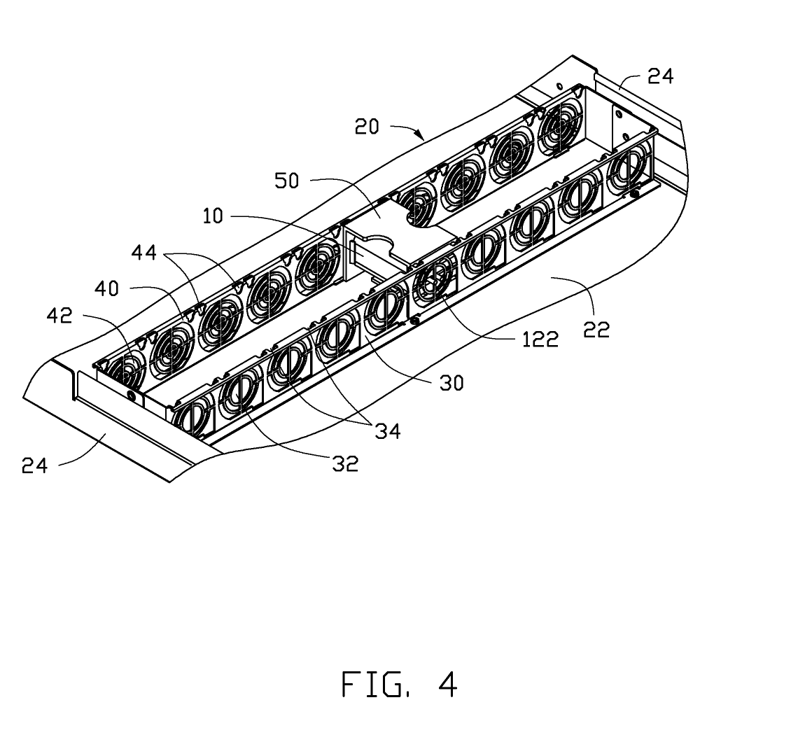

Referring to FIG. 4, the cable 122 is inserted into one first ventilation hole 32 of the first securing plate 30. The bracket 50 is inserted between the first and second securing plates 30, 40. The first positioning posts 542 are engaged into the first positioning slots 34 of the first securing plate 30, and the second positioning posts 562 are engaged into the second positioning slots 44 of the second securing plate 40. Therefore, the bracket 50 is secured between the first and second securing plate 30, 40.

In disassembly, the first and second positioning posts 542, 562 of the bracket 50 are disengaged from the first and second positioning slots 34, 44 of the first and second securing plates 30, 40. Then, the bracket 50 is removed from between the first and second securing plates 30, 40. The locking portions 546 of the bracket 50 are resiliently deformed outward to disengage the locking protrusions 548 from the first end 12 of the cell battery 10. So, the first end 12 of the cell battery 10 can be removed out of the bracket 50 by pulling the cable 122. Therefore, the cell battery 10 can be taken out of the bracket 50.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a chassis;
a first securing plate secured to the chassis;
a second securing plate secured to the chassis; and
a bracket, secured between the first and second securing plates, comprising a top wall, a first sidewall, and a second sidewall; the first and second sidewalls are located on the top wall; the top wall and the first and second sidewalls configured for receiving a cell battery; and the first sidewall defining a receiving slot for receiving a cable of the cell battery.

2. The mounting apparatus of claim 1, wherein the chassis comprises a bottom plate; and the first and second securing plates are substantially parallel to each other and perpendicular to the bottom plate.

3. The mounting apparatus of claim 2, wherein the chassis further comprises two side plates substantially perpendicular to the bottom plate; and the first and second sidewalls are substantially perpendicular to the two side plates.

4. The mounting apparatus of claim 1, wherein a locking portion is disposed on the first sidewall of the bracket and resiliently deformable; and a locking protrusion is located on the locking portion for blocking the cell battery from moving out of the bracket.

5. The mounting apparatus of claim 1, wherein a positioning block is located on the second sidewall for blocking the cell battery from moving out of the bracket.

6. The mounting apparatus of claim 1, wherein an intermediate board is located on the top wall and connected to the first and second sidewalls; and a positioning piece is located on the intermediate board, for blocking the cell battery between the top wall and the positioning piece.

7. The mounting apparatus of claim 6, wherein a guiding piece is located on the intermediate board and connected to the top wall; and a slanted surface is disposed on the guiding piece, for guiding the cell battery between the guiding piece and the positioning piece.

8. The mounting apparatus of claim 1, wherein the first securing plate defines a first positioning slot; the second securing plate defines a second positioning slot; a first positioning post is located on the first sidewall of the bracket and engaged in the first positioning slot; and a second positioning post is located on the second sidewall of the bracket and engaged in the second positioning slot.

9. The mounting apparatus of claim 1, wherein the first securing plate defines a plurality of first ventilation holes; the second securing plate defines a plurality of second ventilation holes corresponding to the plurality of first ventilation holes; and the plurality of first and second ventilation holes are configured for inserting the cable of the cell battery therethrough.

10. A mounting apparatus comprising:
a chassis comprising a bottom plate and two side plates located on the bottom plate;
a first securing plate secured to the bottom plate of the chassis and connected to the two side plates;
a second securing plate secured to the bottom plate of the chassis and connected to the two side plates; and
a bracket secured between the first and second securing plates, for receiving a cell battery.

11. The mounting apparatus of claim 10, wherein the bracket comprises a top wall, a first sidewall and a second sidewall; the first and second sidewalls are located on the top wall; the top wall and the first and second sidewalls are configured for receiving the cell battery; and the first sidewall defines a receiving slot for receiving a cable of the cell battery.

12. The mounting apparatus of claim 10, wherein the two side plates are substantially perpendicular to the bottom plate; and the first and second securing plates are substantially parallel to each other and perpendicular to the bottom plate and the two side plates.

13. The mounting apparatus of claim 11, wherein a locking portion is disposed on the first sidewall of the bracket and resiliently deformable; and a locking protrusion is located on the locking portion for blocking the cell battery from moving out of the bracket.

14. The mounting apparatus of claim 11, wherein a positioning block is located on the second sidewall for blocking the cell battery from moving out of the bracket.

15. The mounting apparatus of claim 11, wherein an intermediate board is located on the top wall and connected to the first and second sidewalls; and a positioning piece is located on the intermediate board, for blocking the cell battery between the top wall and the positioning piece.

16. The mounting apparatus of claim 15, wherein a guiding piece is located on the intermediate board and connected to the top wall; and a slanted surface is disposed on the guiding piece, for guiding the cell battery between the guiding piece and the positioning piece.

17. The mounting apparatus of claim 11, wherein the first securing plate defines a first positioning slot; the second securing plate defines a second positioning slot; a first positioning post is located on the first sidewall of the bracket and engaged in the first positioning slot; and a second positioning post is located on the second sidewall of the bracket and engaged in the second positioning slot.

18. The mounting apparatus of claim 11, wherein the first securing plate defining a plurality of first ventilation holes; the second securing plate defines a plurality of second ventilation holes corresponding to the plurality of first ventilation holes; and the plurality of first and second ventilation holes are configured for inserting the cable of the cell battery therethrough.

19. A mounting apparatus comprising:
a chassis; and
a bracket, secured to the chassis, comprising a top wall, a first sidewall, and a second sidewall; the first and second sidewalls are located on the top wall; a locking portion disposed on the first sidewall and resiliently deformable; and a locking protrusion a positioning block located on the second sidewall;
wherein the locking portion and the locking protrusion are configured for securing a cell battery in the bracket.

20. The mounting apparatus of claim 19, wherein an intermediate board is located on the top wall and connected to the first and second sidewalls; a positioning piece is located on the intermediate board, for blocking the cell battery between the top wall and the positioning piece; a guiding piece is located on the intermediate board and connected to the top wall; and a slanted surface is disposed on the guiding piece, for guiding the cell battery between the guiding piece and the positioning piece.
